(19) United States
(12) Patent Application Publication
(10) Pub. No.: US 2002/0008066 A1
(43) Pub. Date: Jan. 24, 2002

(54) Apparatus and method for improving an osmosis process

(75) Inventors: J. Adams Kirkpatrick, Austin, TX (US); Gerald L. Brooks, Austin, TX (US)

Correspondence Address: Timothy S. Corder, VINSON & ELKINS LLP, 2300 First City Tower, 1001 Fannin Street, Houston, TX, 77002-6760, US

(73) Assignee: Earth Waters, Inc.

(21) Appl. No.: 09/785,583

(22) Filed: Feb. 15, 2001

Related U.S. Application Data
(63) Continuation of application No. PCT/US00/19310, filed on Jul. 17, 2000.
(60) Provisional application No. 60/147,831, filed on Aug. 7, 1999.

(51) Int. Cl. B01D 61/02

(52) U.S. Cl. 210/652; 210/650; 210/723; 210/728

(57) ABSTRACT

An osmosis or reverse osmosis process is improved by addition of a clathrate forming guest material in a solution to be purified. Addition of clathrate forming guest material to a solution to be filtered by reverse osmosis results in higher flow of permeate at lower pressure.

### TECHNICAL FIELD

The present invention relates in general to an apparatus and method for improving an osmosis process, and in particular, to an apparatus and method for improving a reverse osmosis process to purify water by utilizing clathrate formation.

### BACKGROUND OF THE INVENTION

The production of usable water is rapidly becoming a critical issue throughout the world. It is now well recognized that there is a need for unpolluted water. Unpolluted means that water, when in the liquid state, does not contain ions, molecules, viruses, bacteria, or the like at a level that is harmful for the intended use of the water. For instance, for potable water, unpolluted water is defined as at a sufficient level of purity so that when the water is consumed, it is not likely to cause death or illness to a living system (such as a plant, or animal), or to have a foul odor or taste. In most cases, each living system has a specific threshold level of pollution that will cause its death or illness. Also, for instance, when the intended use is for an industrial application, such as for use in the pharmaceutical industry or the chip fabrication industry, the purity of the water must be quite high for it to be unpolluted water.

In nature, pollutants are removed from liquid water by converting liquid waste to the solid or gaseous state, or through filtration. The pollutants may reenter the water cycle when either the solid or gaseous phase of water convert back to the liquid phase of water. Because these natural mechanisms can be inefficient and uneconomical to perform artificially, a mechanism known as osmosis, and more particularly, reverse osmosis has also been utilized.

Osmosis occurs when there is a chemical potential difference across a semipermeable membrane. This difference in chemical potential between a pure solvent on one side of the semi-permeable membrane and that present in a solution on the opposite side of the membrane causes the solution and solvent to seek an equilibrium state. For example, in a solution of sea water, in which sodium and chloride ions are the primary solute particles, that is separated from pure water by a semipermeable membrane, the chemical potential of the sea water would differ from the pure water, due in part to the increase in entropy that occurs when a solid dissolves in a liquid. As is known from the laws of thermodynamics, all physical systems seek their lowest energy level, thus in a simple osmosis reaction, the net flow of water would be from the solvent side (pure water in our example), across the membrane and the solution (sea water) would become more dilute until a state of equilibrium was reached.

A general schematic representation of osmosis is illustrated in FIG. 1. In FIG. 1, a solution (101) containing dissolved solutes is separated from the solvent (102) by a semipermeable membrane (103). In this system, individual molecules of the solvent (102) flow in both directions through the membrane (103) and solute ions or molecules (104) are blocked by the membrane (103). As the system seeks equilibrium, the water molecules on the solution side (106) of the membrane (103) increase. As the amount of water increases on one side of the membrane and is reduced on the other, the height of the water columns (107 and 108) will reflect this relative difference, thus producing a pressure differential (109). When the difference in pressure equalizes the difference in chemical potential, the net flow of water approaches zero. The pressure difference across the membrane is known as the osmotic pressure.

Through the osmosis process, individual water molecules will flow from the pure water side of the membrane through the membrane to dilute the concentration of the polluted water. Usable water would be produced by diluting the polluted water with pure water. Accordingly, osmosis itself does not remove the polluting agent. Rather it only reduces the concentration of the polluting agent.

The equilibrium position of any osmosis system may be changed by changing one or more of the variables that are involved in obtaining the equilibrium position. Such variables are, for instance, temperature, external pressure, concentration difference of the solution and solvent across the semipermeable membrane, and the nature of the membrane. In this way, the net flow of water or solvent can be forced through the membrane against the chemical potential, a process referred to as reverse osmosis. The variables that are most typically manipulated to produce reverse osmosis, are the external pressure and the nature of the membrane. If the external pressure is increased on the solution side of the membrane, to a pressure greater than the osmotic pressure, then the net flow of water or solvent is from the solution across the membrane into the side containing pure water or permeate.

A schematic representation of a reverse osmosis process is shown in FIG. 2. The solution (101) is again separated from the solvent (102) by a semipermeable membrane (103). As pressure (201) is applied to the solution (101) a net flow of solvent moves from the solution into the solvent (105). Over time the amount of pure water or solvent increases and the solution becomes more concentrated.

Commercially available equipment to perform such osmosis and reverse osmosis processes are known in the art. For instance, Desal™ Membrane Products manufactures a Low Pressure Cell Test Unit that utilizes a reverse osmosis process for purifying water. Also, for instance, Waymire Environmental Incorporated supplies reverse osmosis systems for home use (i.e. Waymire's Undersink Reverse Osmosis Systems US-550, US-500P, US-650P). The rate of flow of purified water and the purity of the water obtained is dependent on the pressure applied to the solution (relative to the osmotic pressure) and by the membrane.

The water purification art has recognized the need to reduce the external pressure required for osmosis and reverse osmosis processes while maintaining flow rate and/or purity of the water. For instance, U.S. Pat. No. 3,216,930 issued to Glew (“Glew”), discloses the recovery of potable water using a reverse osmosis process at pressures less than 1000 psi. The method described by Glew, however, required the water from the solution be extracted through a membrane into a liquid two-phase system (such as water dissolved in liquid sulfur dioxide extracting agent and sulfur dioxide dissolved in water). As the water was removed from the solution, the volume of water in the two-phase system would increase. The process disclosed in Glew then required the additional step of removing the water from the two-phase system by a process such as flash distillation, for example, to yield the potable water. The process disclosed in Glew has several disadvantages. It requires the use of a two-phase system of components that are not necessarily readily available. It further requires significant redesign of standard osmosis equipment, and also requires an additional process step, such as flash distillation, to remove the water from the two-phase system.

Accordingly, there is a need for improved osmosis and reverse osmosis processes that maintain flow rate and/or purity at reduced pressures, and which are also readily adapted to existing osmosis and reverse osmosis systems. There is also a need for improved osmosis and reverse osmosis processes that do not require additional separation systems to further purify the water after the osmosis or reverse osmosis processes are completed.

Furthermore, the apparatus in which the osmosis and reverse osmosis processes are performed must be cleaned periodically. Because the semipermeable membrane surface is fouled by the buildup of bacteria, the membrane must also be routinely replaced. Accordingly, there is a need for an improved osmosis and reverse osmosis process that increases the time between cleaning of the apparatus and between replacing of the membrane.

### SUMMARY OF THE INVENTION

The present disclosure is based on the discovery that pollutants, salts and other forms of impurities can be removed from water by combining osmosis and reverse osmosis processes with a modified version of the clathrate process. A clathrate is typically a solid complex in which molecules of one substance are completely enclosed within the crystal structure of the other. When water molecules arrange around specific inert or hydrophobic ions or molecules, these structures have the generalized name of water clathrates. The water molecules, which bond together to form the cage-like structure, are referred to as hosts. The inert or hydrophobic ions or molecules, which occupy the center of the cage-like structure are called the guests.

Examples of materials that can act as guests in water clathrate structures are listed in Table 1 below.

TABLE 1

| Air | Kr | Xe |
|---|---|---|
| Ar | N₂ | O₂ |
| CH₄ | HBr | CH₃OH |
| HCl | C₂H₂ | C₂H₄ |
| HCOOH | PH₃ | C₂H₆ |
| N₂O | quaternary ammonium salt | methylcyclopentane |
| CO₂ | CH₃F | 2,3-dimethylbutane |
| methylcyclohexane | 2-methylbutane | hexamethylethane |
| 2,2-dimethylbutane | 2,2,3-trimethylbutane | cycloheptene |
| 2,2-dimethylpentane | 3,3-dimethylpentane | adamantane |
| cyclooctane | cis-cyclooctene | 2,3-dimethyl-1-butene |
| bicyclo[2,2,2]oct-2-ene | 2,3-dimethyl-2-butene | cis-1,2-dimethylcyclohexane |
| 3,3-dimethyl-1-butene | 3,3-dimethyl-1-butyne | hexachioroethane |
| 1-butylmethylether | 2-adamantanone | benzene |
| tetramethylsilane | isoamyl alcohol | isobutylene |
| cyclohexane | cyclohexene oxide | n-butane |
| cis-2-butene | allene | methylformate |
| norbomane | bicycloheptadiene | iodine |
| acetonitrile | neopentane | toluene |
| n-pentane | n-hexane | trans-1,2-dimethylcyclohexane |
| isoprene | trans-2-butene | 2-methyl-2-butene |
| diethylether | 2,4,-dimethylpentane | 2,2,4-trimethipentane |
| 2-methyl-1-butene | 3-methyl-i -butene | cyclohexanone |
| methyl acetate | t-butylmethyl acetone | |

The present invention utilizes a modified clathrate process because, prior to the present invention, the inventors are aware of no use of clathrates in combination with the osmosis or reverse osmosis processes to improve the quality or quantity of a liquid permeate. Rather, in the past, others have tried to use the formation of solid water clathrates in combination with the freezing process as a means of producing usable water. See, e.g., U.S. Pat. No. 5,553,456 to McCormack (“McCormack”) and U.S. Pat. No. 5,873,262 issued to Max et al. (“Max”). The use of solid clathrates as described in these patents attempted to capitalize on the higher melting points of the water clathrates relative to non-clathrate containing water, thus reducing the energy costs, which would make the freezing of water solutions a practical way of producing usable water.

As disclosed herein the clathrate forming process includes injecting a clathrate forming guest material into the feed stream of a solution undergoing the osmosis process. The guest material, which is generally a gas, although it may also be a solid or liquid, is introduced into the inlet flow stream of the osmosis unit. The amount of guest material that is introduced into the water to be purified is preferably slightly more than the amount of gas that is soluble in the solution.

Without limiting the present invention to any particular theoretical basis, it is Applicants' belief that the formation of water clathrate in the present invention is dependent upon, at least in part, the nature of the guest material, and the temperature and pressure of the solution. Optionally, and if desired, a second clathrate guest forming material can also be introduced into the feed stream. This second guest material can be referred to as a “helper” gas in that it appears to assist in the formation and water purifying activity of the clathrates.

The present inventors have discovered that injection of clathrate forming guest material (or guest materials) into a solution to be purified by reverse osmosis results in purification of more water than would be achieved without the clathrate forming material. The use of the clathrate forming material also produces water that contains fewer impurities than can be achieved under similar conditions in the absence of the clathrate forming material.

The present invention thus offers certain advantages over traditional methods of water purification, i.e. boiling, freezing and reverse osmosis, each of require greater amounts of energy and, other than reverse osmosis, are, in most cases, too costly for large scale commercial utility. The present invention offers the advantage of allowing impurities in water to be removed more efficiently and economically. The present invention also provides the advantage of operation at lower pressures while producing at least the same quantity and quality of purified water than traditional osmosis and reverse osmosis systems are able to produce.

The present invention also has the advantage of requiring no additional equipment or process downstream of the osmosis and reverse osmosis systems to separate the impurities or a second solvent, for example, from the water after the osmosis and reverse osmosis process are complete. In some applications, recycling the clathrate forming material may be desirable, when the guest material is expensive or hard to obtain, for example, thus requiring some minimal downstream equipment.

The present invention provides the further advantage of being readily added to existing osmosis equipment, such as Desal™ Low Pressure Cell Test Units and Waymire's Undersink Reverse Osmosis Systems, thus improving the performance of existing apparatus. Impurities that may be removed from sea water or other impure water sources include, but are not limited to sodium and chloride ions as well as SO₄⁻³, Mg⁻³, Ca⁺², K⁺, HCO₃⁻, Br⁻, Sr⁺², and F⁻. The apparatus and method also provide more efficient removal of any impurity that is unable to penetrate a semi-permeable membrane, such as heavy metals, molecular or organismic pollutants, including herbicides, pesticides, viruses, protists and bacteria.

Another advantage provided by the present invention is that it reduces fouling of the semipermeable membrane surface by the buildup of bacteria and the drag in the tube walls and pipe by minimizing scale and buildup. This buildup is decreased and/or eliminated by varying the clathrate forming guest material. For instance, both air and nitrogen can each be used as the guest material in the present invention. Some bacteria require oxygen to live (aerobic bacteria); other bacteria cannot survive if oxygen is present (anaerobic bacteria). By switching from air to nitrogen and back to air, the fouling of the membrane by biological materials is retarded or eliminated. This retardation and/or elimination of membrane fouling by bacteria reduces downtime and lessens other problems and expenses associated with maintenance.

The foregoing has outlined rather broadly the features and technical advantages of the present invention in order that the detailed description of the invention that follows may be better understood. Additional features and advantages of the invention will be described in greater detail hereinafter.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a schematic representation of an osmosis process;

FIG. 2 is a schematic representation of a reverse osmosis process;

FIG. 3 illustrates, in block diagram form, an improved reverse osmosis device in accordance with an embodiment of the present invention;

FIG. 4 illustrates, in block diagram form, a detailed view of a guest material injector in accordance with an embodiment of the present invention;

FIG. 5 illustrates clathrate formation in a reverse osmosis process; and

FIG. 6 illustrates, in block diagram form, an improved reverse osmosis device in accordance with an embodiment of the present invention.

FIG. 7 is a graphical representation of data reported in Table 2, Example 12.

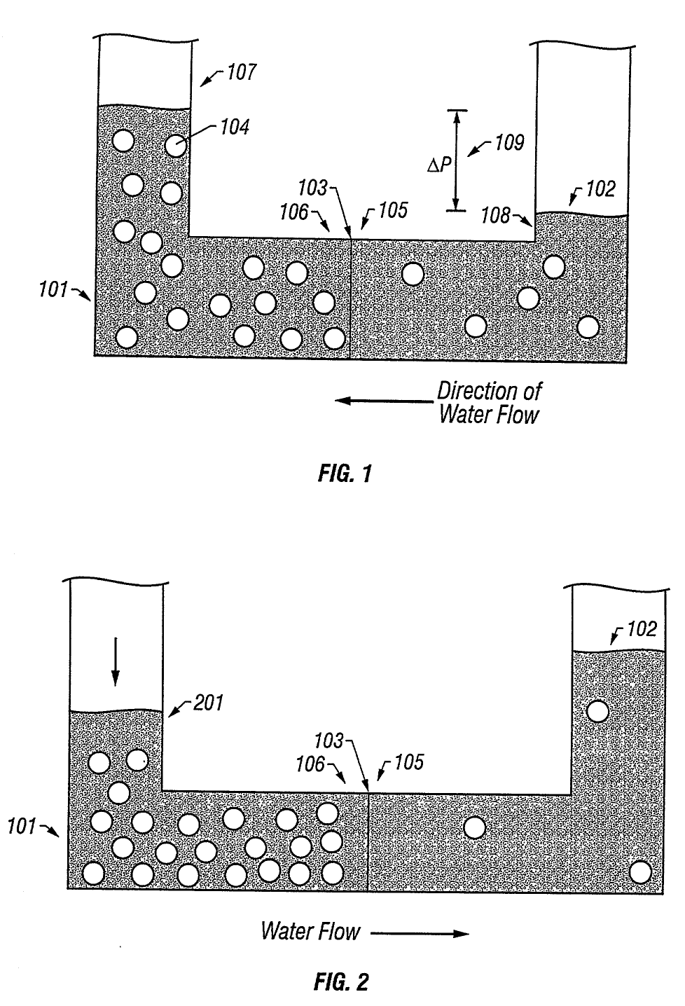

### DETAILED DESCRIPTION

In the following description, numerous specific details are set forth to provide a thorough understanding of the present invention. However, it will be obvious to those skilled in the art that the present invention may be practiced without such specific details. In other instances, well-known devices have been shown in block diagram form in order not to obscure the present invention in unnecessary detail. For the most part, details and the like have been omitted inasmuch as such details are not necessary to obtain a complete understanding of the present invention and are within the skills of persons of ordinary skill in the relevant art.

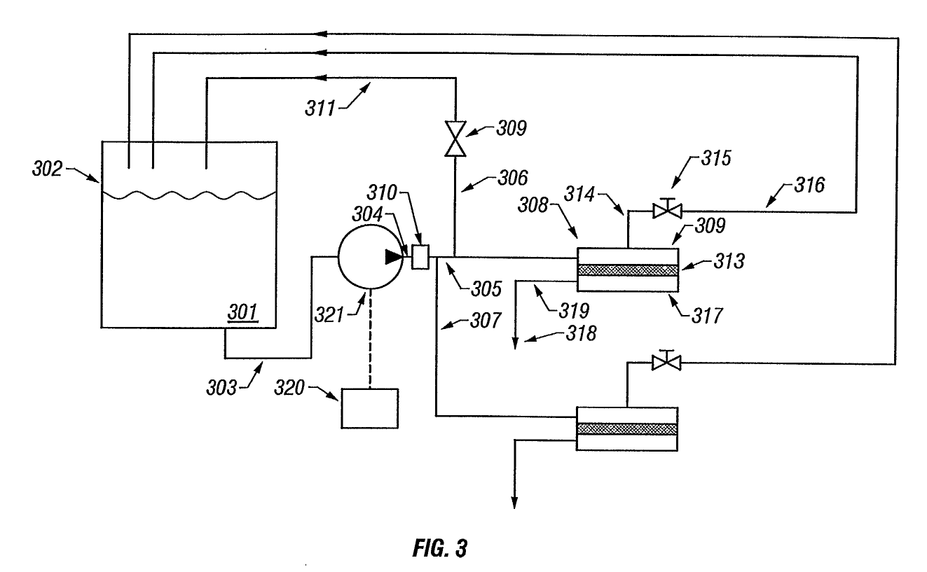

Referring now to the drawings wherein depicted elements are not necessarily shown to scale and wherein like or similar elements are designated by the same reference numeral through the several views, FIG. 3 illustrates an embodiment of an improved reverse osmosis system. Water for purification (301) is stored in feed tank (302). A feed outlet (303) from the feed tank (302) is connected to a pump (321). For example, pump (321) may be a displacement pump for allowing the flow of water from the feed tank to be in the range of 1.5 gallons per minute at a pressure in the range of 200 psig. The pump (321) may be controlled manually. For manual control, the flow rate and pressure of the water (301) can be preset by the operator at controls (320).

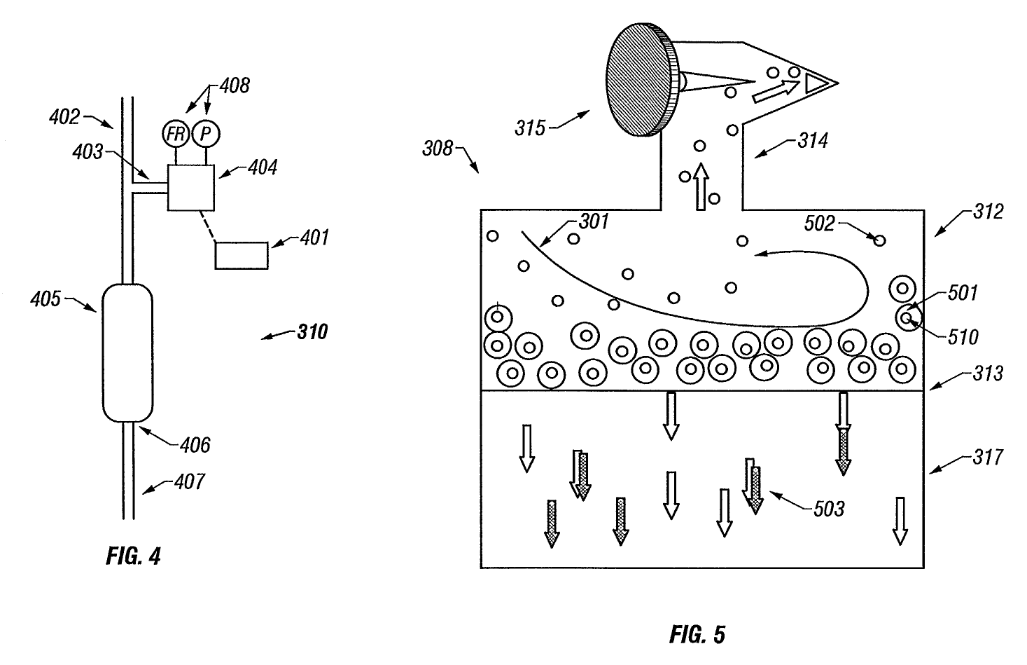

Water (301) is pumped from the pump (321) through the pump manifold (304). Pump manifold (304) is connected to the guest material injector (310), which is described in greater detail in FIG. 4. The guest material injector (310) is connected to test cell conduit (305).

Optionally, and as shown in FIG. 3, test cell conduit (305) may branch to bypass conduit (306). Water may pass through bypass conduit (306), through pressure valve (309), and recycled into the feed tank (302) through bypass conduit (311). Optionally, water from the pump may also branch to other test cell conduits. For instance, in FIG. 3, a second test cell conduit (307) is shown to branch from test cell conduit (305). While not shown in FIG. 3, a guest material injector (310) may be attached downstream of the bypass conduit (305) or in a conduit leading to any alternate test cell (i.e. 307).

Water pumped through a test cell conduit (305) is fed into test cell (308). The water enters test cell (308) on the solution side (309) of the membrane (313). Return conduit (314) is connected to test cell (308) on the solution side (309). Non-purified solution or water may pass through return conduit (314), through back pressure valves (315), and through return conduit (316) to be recycled into feed tank (302).

Through the improved reverse osmosis process, purified water molecules pass through membrane (313) in the test cell (308) into the solvent side (317). Purified water, also referred to as permeate (318), flows through outlet (319) out of the system and may be captured. No further processing of the permeate (318) is necessary.

FIG. 4 is a detailed view of a guest material injector (310). The guest material injector (310) has an inlet tee (402) that can be attached to the pump manifold (304). The inlet tee (402) attaches a supply line (403) in which the guest materials are supplied (404). The guest material supply (404) can be a canister of the guest material stored in a gaseous state, such as compressed air or argon, for example. Alternatively, for instance, if air is to be used as the guest material, a compressor (not shown) can be used to compress surrounding air or a nitrogen tower may be used to obtain nitrogen for injection into the inlet tee (402). The guest material supply may be controlled manually. For manual control, the flow rate and pressure of the guest material (404) can be preset by the operator at controls (401). The guest material mixing control (401) may also be controlled automatically, such as by a computer. In such a case, sensors (408) are attached to the guest material supply (404) to monitor and adjust the pressure and flow rate at which the guest material is introduced into the supply line (403).

The inlet tee (402) is also attached to a chamber (405) in which the guest material from the guest supply (404) is mixed with the water to be purified. In certain preferred embodiments, the mixing chamber (405) is a stainless steel container, cylindrical in shape. The chamber (405) is also attached to a threaded port (406) which leads to an outlet port (407) through which the mixed water and guest material are directed to test cell conduit (305).

FIG. 5 illustrates the interior of a test cell (308). The feed stream of water (301) and guest material (510) enter the test cell (308) on the solution side (312) of the membrane (313). Clathrates are formed as the water molecules arrange themselves around the molecules of the guest material (510) to form the water clathrates (501). While FIG. 5 illustrates the water clathrates (501) in static form, the formation of water clathrates (501) is dynamic, i.e. the clathrates continuously form, disassociate, and reform over extremely short periods of time. It is contemplated that the water clathrates (501) form a layer on top of the membrane (313) and that this mechanism contributes to the effectiveness of the method. It is understood, however, that the understanding of such a mechanism is not necessary to the practice of the present invention, and that this discussion and Figure in no way limit the scope of the attached claims.

It is Applicants' belief that, the stacking of clathrates near the membrane would retard or decrease fouling of the membrane. It is Applicants' further belief that increasing the thickness of the layer of water clathrates (501) (the “apparent thickness”) increases the purity of the permeate (503). The apparent thickness of the layer of clathrates (501) appears to be dependent upon the flow rate of water (301) and guest material (510) across the membrane (313) on the solution side (312) of the test cell (308). The slower the flow rate, the thicker the layers of clathrates (501) above the membrane (313). Control of this flow rate depends, in part, upon the percentage of the water stream entering the test cell (308) which is returned to the feed tank (302) through return conduit (314) and back pressure valves (315) (the “recycle rate”). By decreasing the recycle rate (and keeping all other conditions constant), the flow time of materials through the test cell (308) increases, as does the layer of water clathrates (501). The back pressure valve (315) can be adjusted to change the recycle rate. Note that both the recycle rate and the bypass rate are inversely proportional to pressure and pressure is proportional to clathrate growth. Also note that when the pressure becomes too high, the clathrates may crystallize into solid form.

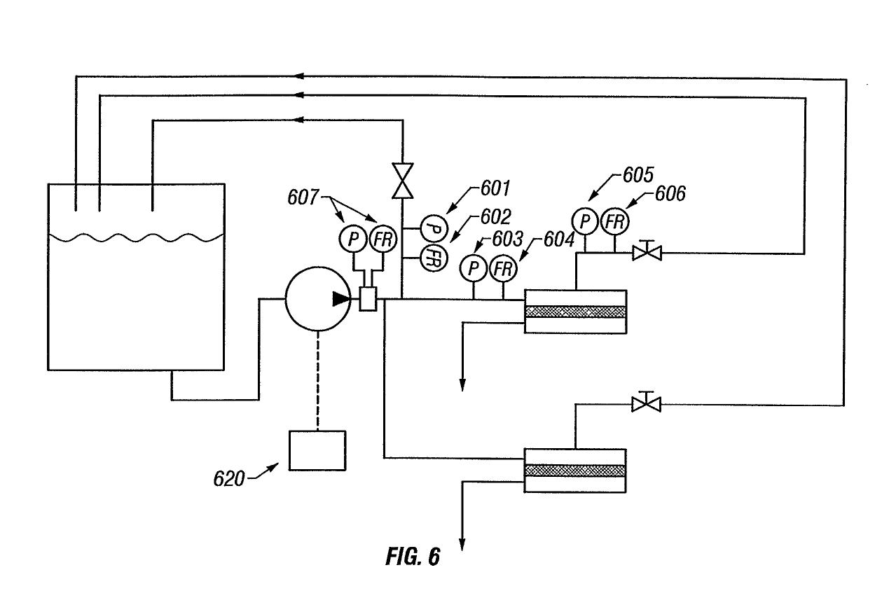

FIG. 6 illustrates an embodiment of the present invention in which the controls for the system are operated automatically. Sensors, such as for example, pressure and flow rate sensors (601-606) are attached to monitor and adjust pressures and flow rates at the sensing points. Pressure and flow rate sensors (601-606) are operatively connected to control (620). Control (620) may be a computer, which, optionally, may be the same computer used for guest material injector control (401) as illustrated in FIG. 4.

Preferred embodiments of the present invention are now described by reference to the following Examples, which are given here for illustrative purposes only and are by no means intended to limit the scope of the present invention.

### EXAMPLE 1

A reverse osmosis procedure was performed using a standard Desal Low Pressure Cell Test Unit. One of the unit's two CPVC test cells (area of 12.56 square inches) was utilized during the procedure. The test cell contained a 12 square inch membrane manufactured by Osmonics/Desal. Examples of such membranes are marketed as AJ, AK, AE, AD, AG, AC, or AF. The water to be purified was a brine having a conductance of 270 μS.

The system pressure was set at 250 psi and the brine was allowed to flow steadily. After five minutes, 44 ml of permeate was collected with a conductance of 22 μS.

### EXAMPLE 2

EXAMPLE 1 was repeated except the pressure of the system was set at 100 psi. After five minutes, 17 ml of permeate had been collected with a conductance of 22 μS.

### EXAMPLE 3

Example 1 was repeated except the pressure of the system was set at 50 psi. After five minutes, 8 ml of permeate had been collected with a conductance of 21 μS.

### EXAMPLE 4

A reverse osmosis procedure was performed using the same Desal Low Pressure Cell Test Unit, which was modified with the guest injector shown in FIG. 5. The mixing chamber of the guest injector was a stainless steel cylinder that was sized at one gallon. The guest that was injected into the system was air.

The conditions of Example 1 were repeated. After five minutes, 50 ml of permeate had been collected with a conductance of 45 μS.

### EXAMPLE 5

Example 4 was repeated except the pressure of the system was set at 100 psi. After five minutes, 20 ml of permeate had been collected with a conductance of 22 μS.

### EXAMPLE 6

Example 4 was repeated except the pressure of the system was set at 50 psi. After five minutes, 12 ml of permeate had been collected with a conductance of 22 μS.

### EXAMPLE 7

Example 4 was repeated except the guest used was argon. After five minutes, 55 ml of permeate had been collected with a conductance of 21 μS.

### EXAMPLE 8

Example 4 was repeated except the gas used was nitrogen. After five minutes, 48 ml of permeate had been collected with a conductance of 26 μS.

### EXAMPLE 9

Example 8 was repeated except the pressure of the system was set at 100 psi. After five minutes, 19 ml of permeate had been collected with a conductance of 21 μS.

### EXAMPLE 10

The purpose of this Example was to show the effects of over-pressurizing the system. The conditions of Example 4 were used with quaternary ammonium salt (QAS) and air as the guest materials. (Air being considered the “helper” gas). At a pressure of 500 psi, the flow rate of permeate was quite slow. When the pressure was reduced by 50% (to 250 psi), keeping all other conditions constant, the permeate flow rate increased many fold.

### EXAMPLE 11

The purpose of this Example is to illustrate a transient response of an embodiment of the invention. The mixing chamber (405) in FIG. 4 is filled with salt water and a guest material, “former gases,” such that the pressure in the mixing chamber is approximately 1500-1800 psi. Then the supply side is sealed and the feed is regulated to a pressure of 250 psi, for Example. The permeate efficiency for the first minute of this run is approximately double the permeate efficiency for the next several minutes. The result may be due to a high pressure flash freeze, or to partial crystallization of hydrate structures in the solution. Based on these observations, it is contemplated by the inventors that the methods and apparatus disclosed herein provide improvements over prior purification schemes in which solid hydrates are formed and removed from a solution by centrifugation.

### EXAMPLE 12

Further studies were undertaken to establish optimal pressures for the clathrate containing reverse osmosis process using argon as the guest material. In these studies, the results of which are reported in Table 2, the volume of permeate in milliliters collected in 5 minutes is recorded. Each data point in the argon containing samples is the average of six trials and for the controls, n=3. The percent increase in permeate at each pressure is shown graphically in Figure

TABLE 2

| | Clathrate | Control | | Clathrate | Control |
|---|---|---|---|---|---|
| 60 psi | | | 400 psi | | |
| volume | 13.15 | 8.9 | volume | 64.83 | 56.20 |
| conductance | 6.4 | 7.4 | conductance | 1.8 | 2.12 |
| temp. | 26.83 | 24.63 | temp. | 23.08 | 22.40 |
| 80 psi | | | 500 psi | | |
| volume | 16.52 | 14.40 | volume | 93.88 | 82.60 |
| conductance | 4.94 | 4.91 | conductance | 1.62 | 2.00 |
| temp. | 26.52 | 26.50 | temp. | 24.45 | 23.73 |
| 100 psi | | | 550 psi | | |
| volume | 20.33 | 17.17 | volume | 82.17 | 70.97 |
| conductance | 3.30 | 4.52 | conductance | 1.79 | 1.81 |
| temp. | 27.1 | 26.50 | temp. | 23.62 | 23.13 |
| 160 psi | | | 600 psi | | |
| volume | 37.15 | 30.53 | volume | 97.05 | 81.37 |
| conductance | 3.48 | 4.35 | conductance | 2.29 | 1.88 |
| temp. | 27.18 | 26.43 | temp. | 24.93 | 24.27 |
| 200 psi | | | 650 psi | | |
| volume | 48.25 | 34.70 | volume | 116.75 | 105.77 |
| conductance | 2.72 | 3.13 | conductance | 1.82 | 2.14 |
| temp. | 27.47 | 24.10 | temp. | 26.10 | 25.67 |
| 300 psi | | | | | |
| volume | 64.88 | 56.27 | | | |
| conductance | 2.26 | 2.44 | | | |
| temp. | 25.08 | 24.30 | | | |

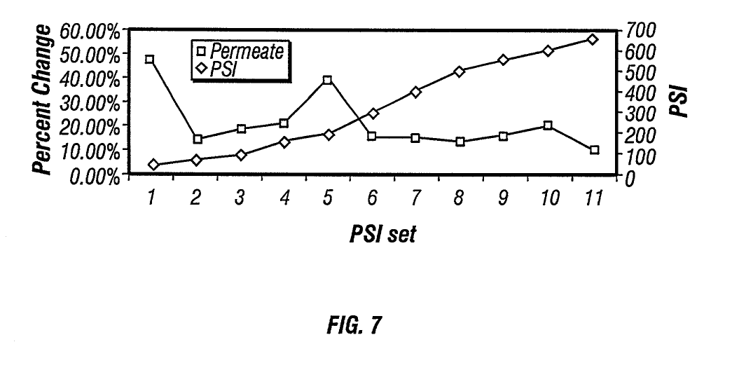

FIG. 7 is a graphical demonstration of the percent increase over control of the volume of permeate obtained at each pressure.

1. A method of producing water purified of solutes comprising:
mixing solute-containing water with one or more clathrate guest materials effective to dissolve or suspend said clathrate guest materials in said water;
contacting a semi-permeable membrane with said non-purified water, wherein said membrane is permeable to water but is not permeable to said solutes; and
collecting purified water that passes through said semi-permeable membrane.

2. A method of removing impurities from water by reverse osmosis comprising:
mixing solute-containing water with one or more clathrate guest materials effective to dissolve or suspend said clathrate guest materials in said water;
subjecting the solute and guest materials containing water to a pressure of from about 700 to about 14 pounds per square inch (psi);
contacting a semi-permeable membrane with the solute and guest materials containing water, wherein said membrane is permeable to water but is not permeable to the solutes; and
collecting purified water that passes through said semi-permeable membrane.

3. A method of desalinating water comprising:
mixing salt-containing water with one or more clathrate guest materials effective to dissolve or suspend said clathrate guest materials in said water;
subjecting the salt-containing water to a pressure of from about 700 to about 14 pounds per square inch (psi);
contacting a semi-permeable membrane with the salt-containing water, wherein said membrane is permeable to water but is not permeable to the salt; and
collecting purified water that passes through said semi-permeable membrane.

4. The method of claim 1, further comprising subjecting the salt-containing water to a pressure of from about 700 to about 14 pounds per square inch (psi).

5. The method of claim 2 comprising subjecting the water to a pressure of from about 200 to about 250 psi.

6. The method of claim 3 comprising subjecting the water to a pressure of from about 200 to about 250 psi.

7. The method of claim 4 comprising subjecting the water to a pressure of from about 200 to about 250 psi.

8. The method of claim 1, wherein said clathrate guest material is air, Kr, Xe, Ar, N₂, O₂, CH₄, HBr, CH₃OH, HCl, C₂H₂, C₂H₄, HCOOH, PH₃, C₂H₆, N₂O, quatenary ammonium salt, methylcyclopentane, CO₂, CH₃F, 2,3-dimethylbutane, methylcyclohexane, 2-methylbutane, hexamethylethane, 2,2-dimethylbutane, 2,2,3-trimethylbutane, cycloheptene, 2,2-dimethylpentane, 3,3-dimethylpentane, adamantane, cyclooctane, cis-cyclooctene, 2,3-dimethyl-1-butene, bicyclo[2,2,2]oct-2-ene, 2,3-dimethyl-2-butene, cis-1,2-dimethylcyclohexane, 3,3 -dimethyl-1-butene, 3,3-dimethyl-1-butyne, hexachloroethane, i-butylmethylether, 2-adamantanone, benzene, tetramethylsilane, isoamyl alcohol, isobutylene, cyclohexane, cyclohexene oxide, n-butane, cis-2-butene, allene, methylformate, norbornane, bicycloheptadiene, iodine, acetonitrile, neopentane, toluene, n-pentane, n-hexane, trans-1,2-dimethylcyclohexane, isoprene, trans-2-butene, 2-methyl-2-butene, diethylether, 2,4,-dimethylpentane, 2,2,4-trimethipentane, 2-methyl-1-butene, 3-methyl-1-butene, cyclohexanone, methyl acetate or t-butylmethyl acetone.

9. The method of claim 2, wherein said clathrate guest material is air, Kr, Xe, Ar, N₂, O₂, CH₄, HBr, CH₃OH, HCl, C₂H₂, C₂H₄, HCOOH, PH₃, C₂H₆, N₂O, quaternary methylcyclopentane, CO₂, CH₃F, 2,3-dimethylbutane, methylcyclohexane, 2-methylbutane, hexamethylethane, 2,2-dimethylbutane, 2,2,3-trimethylbutane, cycloheptene, 2,2-dimethylpentane, 3,3-dimethylpentane, adamantane, cyclooctane, cis-cyclooctene, 2,3-dimethyl-1-butene, bicyclo[2,2,2]oct-2-ene, 2,3-dimethyl-2-butene, cis-1,2-dimethylcyclohexane, 3,3-dimethyl-1-butene, 3,3-dimethyl-1-butyne, hexachloroethane, i-butylmethylether, 2-adamantanone, benzene, tetramethylsilane, isoamyl alcohol, isobutylene, cyclohexane, cyclohexene oxide, n-butane, cis-2-butene, allene, methylformate, norbornane, bicycloheptadiene, iodine, acetonitrile, neopentane, toluene, n-pentane, n-hexane, trans-1,2-dimethylcyclohexane, isoprene, trans-2-butene, 2-methyl-2-butene, diethylether, 2,4,-dimethylpentane, 2,2,4-trimethipentane, 2-methyl-1-butene, 3-methyl-1-butene, cyclohexanone, methyl acetate or t-butylmethyl acetone.

10. The method of claim 3, wherein said clathrate guest material is air, Kr, Xe, Ar, N₂, O_{2,} CH₄, HBr, CH₃OH, HCl, C₂H₂, C₂H₄, HCOOH, PH₃, C₂H₆, N₂O, quaternary methylcyclopentane, CO₂, CH₃F, 2,3-dimethylbutane, methylcyclohexane, 2-methylbutane, hexamethylethane, 2,2-dimethylbutane, 2,2,3-trimethylbutane, cycloheptene, 2,2-dimethylpentane, 3,3-dimethylpentane, adamantane, cyclooctane, cis-cyclooctene, 2,3-dimethyl-1-butene, bicyclo[2,2,2]oct-2-ene, 2,3-dimethyl-2-butene, cis-1,2-dimethylcyclohexane, 3,3-dimethyl-1-butene, 3,3-dimethyl-1-butyne, hexachloroethane, i-butylmethylether, 2-adamantanone, benzene, tetramethylsilane, isoamyl alcohol, isobutylene, cyclohexane, cyclohexene oxide, n-butane, cis-2-butene, allene, methylformate, norbornane, bicycloheptadiene, iodine, acetonitrile, neopentane, toluene, n-pentane, n-hexane, trans-1,2-dimethylcyclohexane, isoprene, trans-2-butene, 2-methyl-2-butene, diethylether, 2,4,-dimethylpentane, 2,2,4-trimethipentane, 2-methyl-1-butene, 3-methyl-1-butene, cyclohexanone, methyl acetate or t-butylmethyl acetone.

11. The method of claim 1, wherein said clathrate guest material is provided as a compressed gas.

12. The method of claim 2, wherein said clathrate guest material is provided as a compressed gas.

13. The method of claim 3, wherein said clathrate guest material is provided as a compressed gas.

14. The method of claim 1, wherein said clathrate guest material is air, argon, nitrogen, nitrous oxide or quaternary ammonium salt.

15. The method of claim 2, wherein said clathrate guest material is air, argon, nitrogen, nitrous oxide or quaternary ammonium salt.

16. The method of claim 3, wherein said clathrate guest material is air, argon, nitrogen, nitrous oxide or quaternary ammonium salt.

17. The method of claim 1, wherein the solution that is to contact the semi-permeable membrane is at a pressure or temperature that is effective to cause crystallization of at least a portion of the clathrate structures present in the solution.

18. The method of claim 2, wherein the solution that is to contact the semi-permeable membrane is at a pressure or temperature that is effective to cause crystallization of at least a portion of the clathrate structures present in the solution.

19. The method of claim 3, wherein the solution that is to contact the semi-permeable membrane is at a pressure or temperature that is effective to cause crystallization of at least a portion of the clathrate structures present in the solution.

20. A system for removing salts or impurities from an aqueous solution comprising:
(a) a cell configured to contain a semi-permeable membrane that separates the interior of said cell into a solution side and a permeate side;
(b) a connection to a source for said solution and means for moving said solution over a semi-permeable membrane contained in said cell;
(c) means for mixing said solution with a clathrate guest material;
(d) means for providing pressure to that portion of said solution that passes over said semi-permeable membrane; and
an outlet for collecting permeate that crosses said semi-permeable membrane.
